(19) United States
(12) Patent Application Publication
(10) Pub. No.: US 2025/0194843 A1
(43) Pub. Date: Jun. 19, 2025

(54) Fruit Juicer And Funnel Assembly

(71) Applicant: Michael Fleming, Reno, NV (US)

(72) Inventor: Michael Fleming, Reno, NV (US)

(21) Appl. No.: 18/538,887

(22) Filed: Dec. 13, 2023

(51) Int. Cl. A47J 19/02; A47J 19/00; B65B 39/00

(52) U.S. Cl. CPC A47J 19/023; A47J 19/005; B65B 39/007; B65B 2039/008

(57) ABSTRACT

A fruit juicer and funnel assembly includes a funnel that has a bowl section and a stem section extending downwardly from the bowl section. The stem section is tapered for directing into a container and the bowl section is in fluid communication with the stem section. A juicer is insertable into the bowl section of the funnel to release juice from a piece of fruit being driven into the juicer. The juicer is in fluid communication with the funnel to direct the juice into the container and the juicer includes a strainer to strain seeds and pulp from the juice. A sleeve is positioned around the funnel for gripping and the sleeve is comprised of a resiliently compressible material to enhance gripping the funnel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fruit juicer devices and more particularly pertains to a new fruit juicer device for directing juice squeezed from fruit into a container. The device includes a funnel and a juicer that is integrated into the funnel to facilitate juice from a piece of fruit to be routed directly into a container. The device includes a sleeve that is positioned around the funnel to enhance gripping the funnel.

### (2) Description of Related Art Including Information Disclosed Under 37 CFR 1.97 and 1.98

The prior art relates to fruit juicer devices including a variety of fruit juicer devices that each includes a press that is manipulated to squeeze juice from a piece of fruit. In no instance does the prior art disclose a fruit juicer device that includes a conical juicer integrated into a funnel to direct juice from a piece of fruit into a container.

### BRIEF SUMMARY OF THE INVENTION

An embodiment of the disclosure meets the needs presented above by generally comprising a funnel that has a bowl section and a stem section extending downwardly from the bowl section. The stem section is tapered for directing into a container and the bowl section is in fluid communication with the stem section. A juicer is insertable into the bowl section of the funnel to release juice from a piece of fruit being driven into the juicer. The juicer is in fluid communication with the funnel to direct the juice into the container and the juicer includes a strainer to strain seeds and pulp from the juice. A sleeve is positioned around the funnel for gripping and the sleeve is comprised of a resiliently compressible material to enhance gripping the funnel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a fruit juicer and funnel assembly according to an embodiment of the disclosure.

FIG. 2 is an exploded perspective view of an embodiment of the disclosure.

FIG. 3 is a front view of an embodiment of the disclosure.

FIG. 4 is a top view of an embodiment of the disclosure.

FIG. 5 is a bottom view of an embodiment of the disclosure.

FIG. 6 is a cross sectional view taken along line 6-6 of FIG. 4 of an embodiment of the disclosure.

FIG. 7 is a cross sectional in-use view taken along line 6-6 of FIG. 4 of an embodiment of the disclosure.

### DETAILED DESCRIPTION OF THE INVENTION

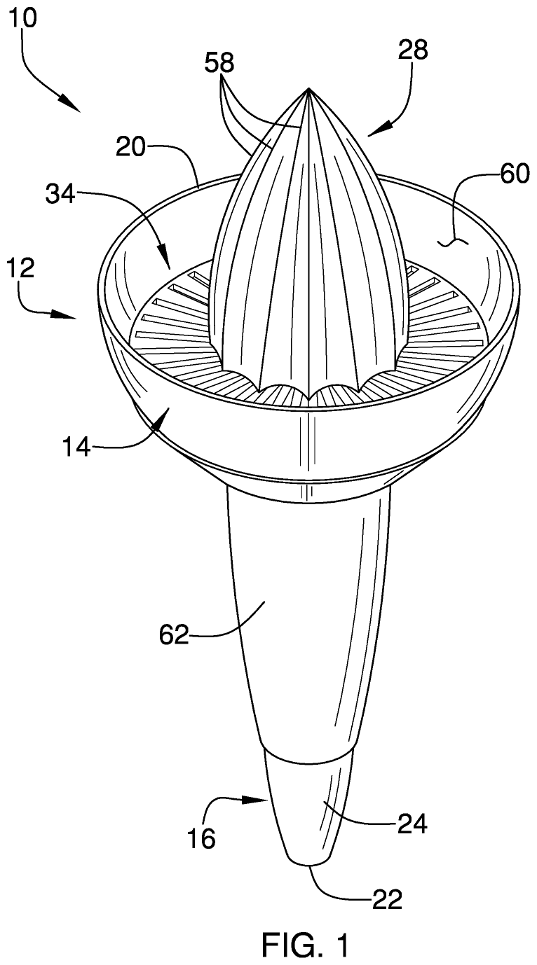

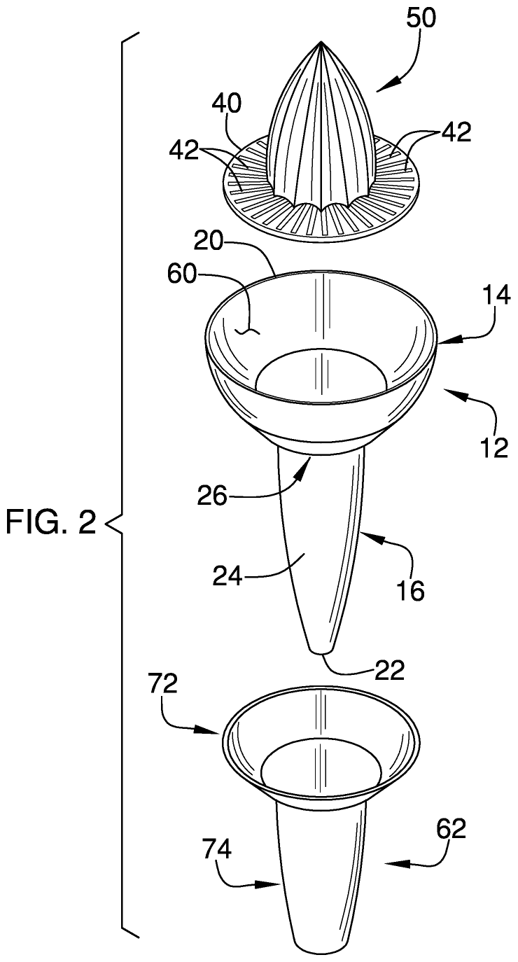

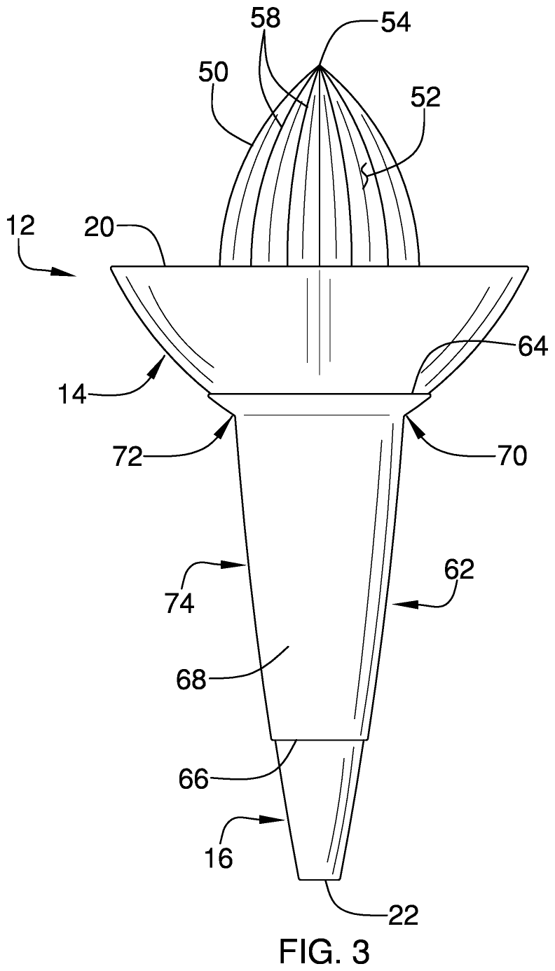

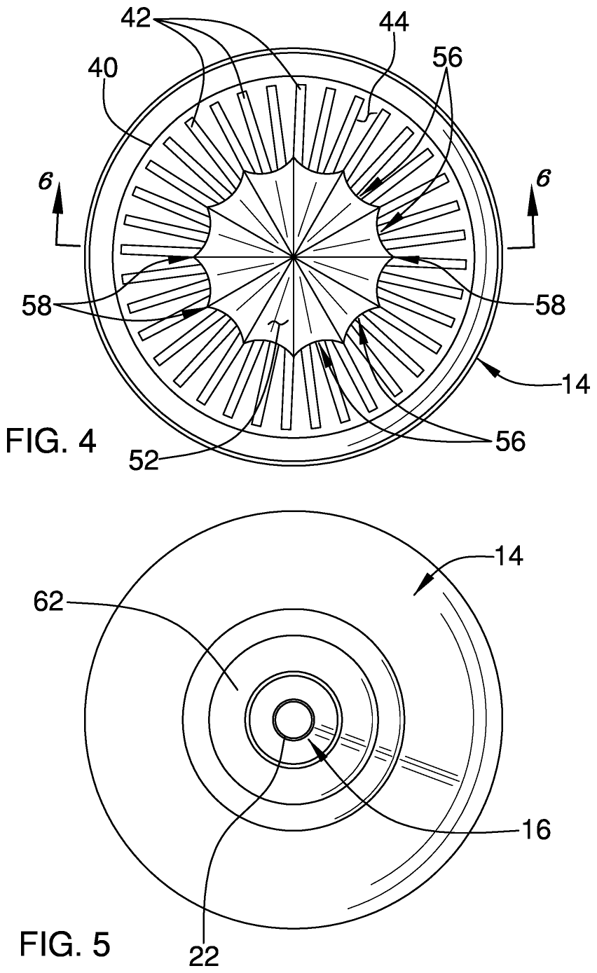

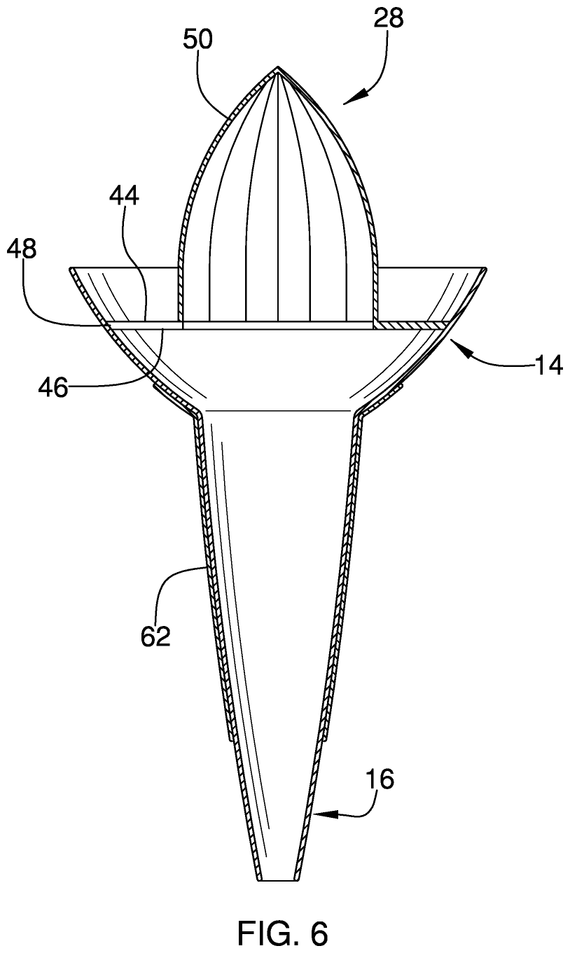

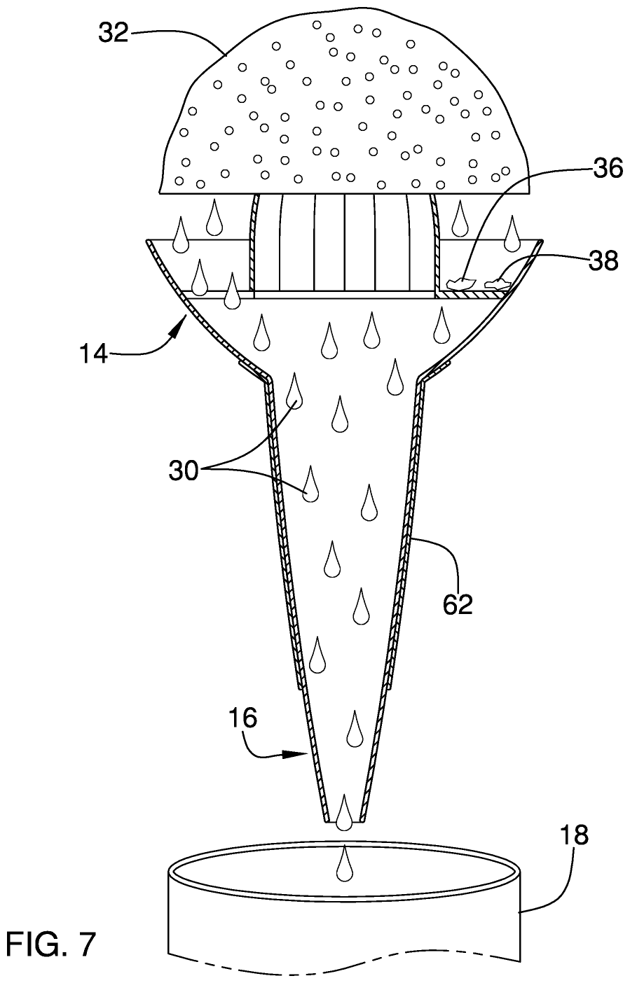

With reference now to the drawings, and in particular to FIGS. 1 through 7 thereof, a new fruit juicer device embodying the principles and concepts of an embodiment of the disclosure and generally designated by the reference numeral 10 will be described.

As best illustrated in FIGS. 1 through 7, the fruit juicer and funnel assembly 10 generally comprises a funnel 12 that has a bowl section 14 and a stem section 16 extending downwardly from the bowl section 14 and the bowl section 14 is in fluid communication with the stem section 16. The stem section 16 is tapered to facilitate the stem section 16 to be inserted into a container 18, which could be a beverage container, a bowl, a skillet or any other container that might commonly be employed for containing a liquid for consumption as a beverage or for containing a liquid for the purposes of cooking a recipe, for example. The funnel 12 has a top end 20, a bottom end 22 and an outer wall 24 extending between the top end 20 and the bottom end 22 and the outer wall 24 is continuously arcuate about an axis extending between the top end 20 and the bottom end 22 such that the funnel 12 has a cylindrical shape. The outer wall 24 curves outwardly and upwardly between the top end 20 and an intersection point 26 which is located closer to the top end 20 than the bottom end 22 to define the bowl section 14. Additionally, the outer wall 24 tapers inwardly between the intersection point 26 and the bottom end 22 to define the stem section 16. The intersecting point 26 has a diameter that is substantially less than a diameter of the top end 20 and the bottom end 22 has a diameter that is less than the diameter of the intersection point 26.

A juicer 28 is insertable into the bowl section 14 of the funnel 12 to the juicer 28 to release juice 30 from a piece of fruit 32 that is driven into the juicer 28. The piece of fruit 32 may be a slice of orange, a slice of grapefruit, a slice of lemon or any other type of fruit that is commonly pressed to produce juice 30. The juicer 28 is in fluid communication with the funnel 12 to facilitate the funnel 12 to direct the juice 30 into the container 18. In this way the juice 30 from the piece of fruit 32 can be employed for mixing a cocktail, for example, or to enjoy the juice 30 as a standalone beverage. The juicer 28 includes a strainer 34 to strain seeds 36 and pulp 38 from the juice 30.

The strainer 34 comprises a disk 40 that has a plurality of slots 42 each extending through a top surface 44 and a bottom surface 46 of the disk 40 and the plurality of slots 42 are evenly spaced apart from each other and are arranged to form a ring. Each of the plurality of slots 42 is elongated to extend from a point that is spaced from a perimeter edge 48 of the disk 40 toward a center of the disk 40. The juicer 28 comprises a cone 50 which extends upwardly from the top surface 44 of the disk 40 and the cone 50 is centrally located on the top surface 44 such that the cone 50 is surrounded by the plurality of slots 42.

The cone 50 has an outer surface 52 which tapers to a point between the top surface 44 and a distal end 54 of the cone 50. The outer surface 52 has a plurality of valleys 56 each extending between the distal end 54 and the top surface 44 of the disk 40 and the valleys 56 are evenly spaced apart from each other and are distributed around the cone 50. Each of the valleys 56 is concavely arcuate to define a plurality of ridges 58 extending between the distal end 54 and the top surface 44 of the disk 40. In this way the plurality of ridges 58 can compress the fruit 32 and the valleys 56 facilitates juice 30 from the juice 30 to run downwardly along the juicer 28 and through the slots 42 in the disk 40. The perimeter edge 48 of the disk 40 abuts an inside surface 60 of the outer wall 24 of the bowl section 14 of the funnel 12 having the juicer 28 being vertically oriented in the bowl section 14 of the funnel 12.

A sleeve 62 is provided which is positioned around the funnel 12 thereby facilitating the sleeve 62 to be gripped. The sleeve 62 is comprised of a resiliently compressible material, including but not being limited to rubber or silicone, such that the sleeve 62 enhances gripping the funnel 12. The sleeve 62 has an upper end 64, a lower end 66 and an outside wall 68 extending between the upper end 64 and the lower end 66. The outside wall 68 is continuously arcuate about an axis extending between the upper end 64 and the lower end 66 such that the funnel 12 has a cylindrical shape. The outside wall 68 curves outwardly and upwardly between the upper end 64 and an intersection point 70 which is located closer to the upper end 64 than the lower end 66 to define a bowl section 72 of the sleeve 62. Furthermore, the outside wall 68 tapers inwardly between the intersection point 70 of the outside wall 68 and the lower end 66 to define a stem section 74 of the sleeve 62. The sleeve 62 insertably receives the funnel 12 having the bowl section 14 of the funnel 12 resting in the bowl section 72 of the sleeve 62. Additionally, the stem section 16 of the funnel 12 extends downwardly in the stem section 74 of the sleeve 62 such that the bottom end 22 of the funnel 12 is exposed.

In use, the sleeve 62 is gripped and the bottom end 22 of the funnel 12 is inserted into the container 18. The piece of fruit 32 is pressed into the juicer 28 in order to squeeze the juice 30 from the piece of fruit 32. Furthermore, the strainer 34 strains the seeds 36 and pulp 38 from the juice 30 and the funnel 12 directs the juice 30 into the container 18. In this way the freshly squeezed juice 30 can be routed directly into the container 18 while mixing a cocktail, for example, for cooking a recipe which requires juice 30, to enjoy the juice 30 as a standalone beverage, or for any other purpose that involves the employment of the freshly squeezed juice 30. Additionally, the funnel 12 and juicer 28 can be easily rinsed off after use for storage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fruit juicer and funnel assembly for juicing a fruit and routing the resulting juice into a container, said assembly comprising:
a funnel having a bowl section and a stem section extending downwardly from said bowl section, said stem section being tapered wherein said stem section is configured to be directed into a container, said bowl section is in fluid communication with said stem section;
a juicer being insertable into said bowl section of said funnel wherein said juicer is configured to release juice from a piece of fruit being driven into said juicer, said juicer being in fluid communication with said funnel wherein said funnel is configured to direct the juice into the container, said juicer including a strainer being configured to strain seeds and pulp from the juice; and
a sleeve being positioned around said funnel wherein said sleeve is configured to be gripped, said sleeve being comprised of a resiliently compressible material wherein said sleeve is configured to enhance gripping said funnel.

2. The assembly according to claim 1, wherein:
said funnel has a top end and a bottom end and an outer wall extending between said top end and said bottom end, said outer wall being continuously arcuate about an axis extending between said top end and said bottom end such that said funnel has a cylindrical shape;
said outer wall curves outwardly and upwardly between said top end and an intersection point located closer to said top end than said bottom end to define said bowl section;
said outer wall tapers inwardly between said intersection point and said bottom end to define said stem section; and
said intersecting point has a diameter being substantially less than a diameter of said top end, said bottom end having a diameter being less than said diameter of said intersection point.

3. The assembly according to claim 1, wherein:
said strainer comprises a disk having a plurality of slots each extending through a top surface and a bottom surface of said disk;
said plurality of slots are evenly spaced apart from each other and are arranged to form a ring;
each of said plurality of slots is elongated to extend from a point being spaced from a perimeter edge of said disk toward a center of said disk;
said juicer comprises a cone extending upwardly from said top surface of said disk; and
said cone is centrally located on said top surface such that said cone is surrounded by said plurality of slots.

4. The assembly according to claim 3, wherein:
said cone has an outer surface tapering to a point between said top surface and a distal end of said cone;
said outer surface has a plurality of valleys each extending between said distal end and said top surface of said disk;
said valleys are evenly spaced apart from each other and are distributed around said cone; and
each of said valleys is concavely arcuate to define a plurality of ridges extending between said distal end and said top surface of said disk wherein said plurality of ridges is configured to compress the fruit and said valleys facilitates juice from the fruit to run downwardly along said juicer and through said slots in said disk.

5. The assembly according to claim 1, wherein:
said bowl section of said funnel has an outer wall;
said juicer includes a disk having a perimeter edge; and
said perimeter edge of said disk abuts an inside surface of said outer wall of said bowl section having said juicer being vertically oriented in said bowl section.

6. The assembly according to claim 1, wherein:
said sleeve has an upper end and a lower end and an outside wall extending between said upper end and said lower end, said outside wall being continuously arcuate about an axis extending between said upper end and said lower end such that said funnel has a cylindrical shape;
said outside wall curves outwardly and upwardly between said upper end and an intersection point located closer to said upper end than said lower end to define a bowl section of said sleeve; and
said outside wall tapers inwardly between said intersection point and said lower end to define a stem section of said sleeve.

7. The assembly according to claim 6, wherein said sleeve insertably receives said funnel having said bowl section of said funnel resting in said bowl section of said sleeve and having said stem section of said funnel extending downwardly in said stem section of said sleeve having a bottom end of said funnel being exposed.

8. A fruit juicer and funnel assembly for juicing a fruit and routing the resulting juice into a container, said assembly comprising:
a funnel having a bowl section and a stem section extending downwardly from said bowl section, said stem section being tapered wherein said stem section is configured to be directed into a container, said bowl section being in fluid communication with said stem section, said funnel having a top end and a bottom end and an outer wall extending between said top end and said bottom end, said outer wall being continuously arcuate about an axis extending between said top end and said bottom end such that said funnel has a cylindrical shape, said outer wall curving outwardly and upwardly between said top end and an intersection point located closer to said top end than said bottom end to define said bowl section, said outer wall tapering inwardly between said intersection point and said bottom end to define said stem section, said intersecting point having a diameter being substantially less than a diameter of said top end, said bottom end having a diameter being less than said diameter of said intersection point;
a juicer being insertable into said bowl section of said funnel wherein said juicer is configured to release juice from a piece of fruit being driven into said juicer, said juicer being in fluid communication with said funnel wherein said funnel is configured to direct the juice into the container, said juicer including a strainer being configured to strain seeds and pulp from the juice, said strainer comprising a disk having a plurality of slots each extending through a top surface and a bottom surface of said disk, said plurality of slots being evenly spaced apart from each other and being arranged to form a ring, each of said plurality of slots being elongated to extend from a point being spaced from a perimeter edge of said disk toward a center of said disk, said juicer comprising a cone extending upwardly from said top surface of said disk, said cone being centrally located on said top surface such that said cone is surrounded by said plurality of slots, said cone having an outer surface tapering to a point between said top surface and a distal end of said cone, said outer surface having a plurality of valleys each extending between said distal end and said top surface of said disk, said valleys being evenly spaced apart from each other and being distributed around said cone, each of said valleys being concavely arcuate to define a plurality of ridges extending between said distal end and said top surface of said disk wherein said plurality of ridges is configured to compress the fruit and said valleys facilitates juice from the fruit to run downwardly along said juicer and through said slots in said disk, said perimeter edge of said disk abutting an inside surface of said outer wall of said bowl section having said juicer being vertically oriented in said bowl section; and
a sleeve being positioned around said funnel wherein said sleeve is configured to be gripped, said sleeve being comprised of a resiliently compressible material wherein said sleeve is configured to enhance gripping said funnel, said sleeve having an upper end and a lower end and an outside wall extending between said upper end and said lower end, said outside wall being continuously arcuate about an axis extending between said upper end and said lower end such that said funnel has a cylindrical shape, said outside wall curving outwardly and upwardly between said upper end and an intersection point located closer to said upper end than said lower end to define a bowl section of said sleeve, said outside wall tapering inwardly between said intersection point and said lower end to define a stem section of said sleeve, said sleeve insertably receiving said funnel having said bowl section of said funnel resting in said bowl section of said sleeve and having said stem section of said funnel extending downwardly in said stem section of said sleeve having said bottom end of said funnel being exposed.
